(19) United States
(12) Patent Application Publication
(10) Pub. No.: US 2007/0200769 A1
(43) Pub. Date: Aug. 30, 2007

(54) Broadband antenna unit comprising a ground plate having a lower portion where both side corner portions are deleted

(75) Inventors: Hisamatsu Nakano, Tokyo (JP); Satoshi Hattori, Tokyo (JP); Junji Yamauchi, Tokyo (JP); Akira Miyoshi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/699,816

(22) Filed: Jan. 30, 2007

(30) Foreign Application Priority Data
Feb. 28, 2006 (JP) 2006-53116

(51) Int. Cl. H01Q 1/38

(52) U.S. Cl. 343/700 MS; 343/846

(57) ABSTRACT

In a broadband antenna unit having a ground plate and an elliptically shaped radiation element disposed at an upper portion of the ground plate in a plane where the ground plate extends, the ground plate has a semi-elliptically shaped upper edge and a lower portion where both side corner portions are deleted with a central portion left. The ground plate and the radiation element are formed on a substrate.

This application claims priority to prior Japanese patent application JP 2006-53116, the disclosure of which is incorporated herein by reference.

### BACKGROUND OF THE INVENTION

This invention relates to a broadband antenna unit and, more particular, to an antenna for an ultra wideband (UWB).

The UWB technology means an ultra wideband radio technology like its name and is defined as any radio technology having a spectrum that occupies a bandwidth greater than 25 percent of the center frequency, or a bandwidth of at least 1.5 GHz. In a word, the UWB technology is technology for communicating using short pulses (normally each having a pulse width of 1 ns or less) of ultra wideband so as to start a revolution in radio technology.

A crucial difference between a conventional radio technology and the UWB technology is the presence or absence of a carrier wave. The conventional radio technology modulates a sinusoidal wave having a frequency called the carrier wave using various methods to transmit and receive data. On the other hand, the UWB technology does not the carrier wave. In the manner which is written in definition of the UWB technology, the UWB technology uses the short pulses of the ultra wideband.

Like its name, the UWB technology has a frequency band of the ultra wideband. On the other hand, the conventional radio technology has only a narrow frequency band. This is because it is possible to the narrow frequency band to put electric waves to practical use. The electric waves are finite resources. The reason whey the UWB technology is widely noticed in spite of the ultra wideband is output energy of each frequency. The UWB technology has a vary small output each frequency in place of a wide frequency band. Inasmuch as the output of the UWB technology has magnitude so as to be covered with noises, the UWB technology reduces interface with other wireless spectra. In the United States, the Federal Communications Commission (FCC) has mandated that UWB radio transmissions can legally operate in range from 3.1 GHz to 10.6 GHz, at a limited transmit power of −4.1 dBm/MHz.

In addition, antennas basically use a resonance phenomenon. The antenna has a resonance frequency which is determined by its length, it is difficult for the UWB including a lot of frequency components to make the antenna for UWB resonate. Accordingly, the wider the frequency band of the electric wave to be transmitted is, the more difficult it makes a plan for the antenna for UWB.

Taiyo Yuden Co. Ltd. has successfully developed a very miniaturized ceramic chip antenna having a size of 10×8×1 mm for ultra wideband applications. Since UWB technology was released by the FCC commercial use, it has been hailed as the short-range wires-communication standard of the future. For one thing, it promises to simultaneously provide a high data rate and low power consumption. By sending very low-power pulses below the transmission-noise threshold, UWB also avoids interference. By developing the antenna, it has become the responsibility of the wireless industry to help UWB make the transition from military applications to widespread commercial use for connecting at a very high speed data between digital devices such as PDP (plasma display panel) television, a digital camera, or the like.

In addition, such a UWB antenna can be used for various purposes such as Bluetooth (registered trademark), wireless LAN (local area network), or the like.

Bluetooth (registered trademark) technology is a cutting-edge open specification that enables short-range wireless connections between desktop and notebook computers, handhelds, personal digital assistants, mobile phones, camera phones, printers, digital cameras, handsets, keyboards and even a computer mouse. Bluetooth wireless technology uses a globally available frequency band (2.4 GHz) for worldwide compatibility. In a nutshell, Bluetooth technology unplugs your digital peripherals and makes cable clutter a thing of the past.

The wireless LAN is an LAN using a transmission path except for a wire cable, such as electric waves, infrared rays, or the like.

Various broadband antenna devices are already known in the art. By way of example, JP 2003-273638 A discloses a wideband antenna device with which interference to be exerted by an unwanted frequency band or a frequency band out of a target is reduced by forming the wideband antenna device matched with target frequency characteristics. According to JP 2003-273638 A, the wideband antenna device comprises a flat conductive ground plate and a flat radiation conductor standing up above a plane of the flat conductive ground plate in a direction to intersect the flat conductive ground plate. The wideband antenna device has a feeding point on or near an outer peripheral portion of the flat radiation conductor. The flat radiation conductor has one or more notches formed by cutting a part of the flat radiation conductor.

In addition, JP 2003-283233 A discloses a wideband antenna device with a wide band and a small size that counters the problems such that costs, usage purposes or mounting on equipment and that cuts manufacturing costs. According to JP 2003-283233 A, the wideband antenna device comprises a flat conductive ground plate and a polygonal flat radiation conductor standing up above a plane of the flat conductive ground plate in a direction to intersect the flat conductive ground plate. The polygonal flat radiation conductor has a top which is used as a signal feeding point.

Furthermore, JP 2003-304114 A discloses a wideband antenna device which uses a plate-shaped radiation conductor as a radiation conductor and which can be made more compact. According to JP 2003-304114 A, the wideband antenna device comprises a flat conductive ground plate and a flat radiation conductor standing up above a plane of the flat radiation ground plate in a direction to intersect the flat conductive ground plate. In a state where the flat radiation conductor stands up above the plane of the flat conductive ground plate, the flat radiation conductor comprises a plurality of conductive portions so as to arrange in the direction to intersect the flat conductive ground plate. Through a low conductivity member having conductivity of almost 0.1 or more and 10.0 or less, the plurality of conductive portions are connected.

In the wideband antenna devices disclosed in the above-mentioned JP 2003-273638 A, JP 2003-283233 A, and JP 2003-304114, the flat radiation conductor stands up above the plane of the flat conductive ground plate in the direction to intersect the flat conductive ground plate. Therefore, the wideband antenna devices are high in stature.

A thin-type wideband antenna device is disclosed in JP 2003-304115 A which corresponds to U.S. Pat. No. 6,914,561 issued to Shinichi Kuroda et al. According to JP 2003-304115 A, the thin-type wideband antenna device includes a reference conductor (conductive ground plate) and a radiation conductor that are connected with a feeder line for transmitting power, at least parts of which are disposed so as to face each other. Interposed between the parts that the reference conductor and the radiation conductor face each other, a substance has conductivity which is about 0.1 [/Ωm] through 10 [/Ωm] in the operational radio frequency.

Inasmuch as the thin-type wideband antenna device disclosed in JP 2003-304115 A includes the conductive ground plate and the radiation conductor which face each other, it is difficult to make thin because the wideband antenna device has thickness a certain extent.

On the other hand, some of the present co-inventors have already proposed an ultra wideband (UWB) antenna unit which is capable of widening the band and which is capable of improving a frequency characteristic in JP 2005-94437 A which corresponds to U.S. Pat. No. 7,081,859 issued to Akira Miyoshi et al. According to JP 2005-94437 A, the UWB antenna unit comprises an upper dielectric, a lower dielectric, and a conductive pattern sandwiched therebetween. The conductive pattern has a feeding point at a substantially center portion of a front surface. The conductive pattern comprises a reversed triangular portion having a right-hand taper part and a left-hand taper part which widen from the feeding point at a predetermined angle toward a right-hand side surface and a left-hand side surface, respectively, and a rectangular portion having a base side being in contact with an upper side of the reversed triangular portion. In addition, the feeding point of the conductive pattern is electrically connected to a ground plate which extends in a plane similar to that of the conductive pattern (a radiation element).

Inasmuch as the UWB antenna unit disclosed in JP 2005-94437 A has structure of the radiation element where the conductive pattern is sandwiched between the upper dielectric and the lower dielectric, it is unsuitable to make thin because the UWB antenna unit has thickness a certain extent in the manner similar in a case of the above-mentioned JP 2003-304115 A.

Furthermore, an elliptically shaped ring broadband antenna is reported by Satoshi Hattori et al in a first paper contributed to 2005 National Convention of the Institute of Electronics, Information and Communication Engineers of Japan as Paper No. B-1-104, Osaka, Japan, May, 2005, under the title of “An Elliptically Shaped Ring Broadband Antenna.” In the manner which will later be described in conjunction with FIGS. 1 and 2, in the elliptically shaped ring broadband antenna reported in the first paper, an elliptically shaped radiation element has an outside diameter in a major axis direction of 24 mm and a ground plate has a square with a side of 45 mm. It is therefore disadvantageous in that the ground plate has a size lager than that of the radiation element. It is desirable to shrink the size of the ground plate in the elliptically shaped ring broadband antenna.

Another elliptically shaped ring broadband antenna is reported by Satoshi Hattori et al in a second paper contributed to 2005 Communication Society Convention of the Institute of Electronics, Information and Communication Engineers of Japan as Paper No. B-1-82, Hokkaido, Japan, September 2005, under the title of “An Elliptically Shaped Ring Broadband Antenna—Part II.” In the manner which will later be described in conjunction with FIGS. 3 through 6, the elliptically shaped ring broadband antenna reported in the second paper comprises a ground plate having a semi-elliptically shaped upper edge. However, it is disadvantageous in that a gain in a +z direction decreases at or more than a frequency of 9 GHz.

### SUMMARY OF THE INVENTION

It is therefore an object of the present invention to provide a broadband antenna unit which is capable of improving a gain at or more than a frequency of 9 GHz.

Other objects of this invention will become clear as the description proceeds.

According to an aspect of this invention, a broadband antenna unit comprises a ground plate and an elliptically shaped radiation element disposed at an upper portion of the ground plate in a plane where the ground plate extends. The ground plate has a semi-elliptically shaped upper edge and a lower portion where both side corner portions are deleted with a central portion left.

In the broadband antenna unit according to the aspect of this invention, the broadband antenna unit further may comprise a substrate on which the ground plate and the radiation element are formed. The radiation element and the ground plate preferably may be apart from each other by a predetermined feeding distance. The elliptically shaped radiation element has a major outside diameter in an ellipse's major axis direction and a minor outside diameter in an ellipse's minor axis direction. In this event, a ratio between the major outside diameter and the minor outside diameter desirably may be 8:5. The elliptically shaped radiation element preferably may have an elliptically shaped opening which is concentric with the elliptically shaped radiation element. The elliptically shaped opening has a minor inside diameter in the ellipse's minor axis direction and a major inside diameter in the ellipse's major axis direction. Under the circumstances, the minor inside diameter desirably may be half of the minor outside diameter and the major inside diameter preferably may be not more than half of the major outside diameter.

### BRIEF DESCRIPTION OF THE DRAWING

FIG. 1 is a plan view showing a first conventional broadband antenna unit;

FIG. 2 is an enlarged plan view showing a radiation element for use in the broadband antenna unit illustrated in FIG. 1;

FIG. 3A is a plan view showing of a second conventional broadband antenna unit;

FIG. 3B is a side view showing the second conventional broadband antenna unit illustrated in FIG. 3A;

FIG. 4 is a view showing a frequency characteristic of VSWR of the broadband antenna unit illustrated in FIGS. 3A and 3B;

FIG. 5A is a view showing a radiation pattern of the second conventional broadband antenna unit illustrated in FIGS. 3A and 3B at a frequency f of 6 GHz;

FIG. 5B is a view showing a radiation pattern of the first conventional broadband antenna unit illustrated in FIG. 1 at a frequency f of 6 GHz;

FIG. 6 is a view showing frequency characteristics of gains in a +z direction of the first and the second conventional broadband antenna units illustrated in FIG. 1 and FIGS. 3A and 3B;

FIG. 7A is a plan view showing a broadband antenna unit according to an embodiment of this invention;

FIG. 7B is a side view showing the broadband antenna unit illustrated in FIG. 7A;

FIG. 8 is a view showing a frequency characteristic of VSWR of the broadband antenna unit illustrated in FIGS. 7A and 7B;

FIG. 9A is a view showing a radiation pattern of the broadband antenna unit illustrated in FIGS. 7A and 7B at a frequency f of 10 GHz;

FIG. 9B is a view showing a radiation pattern of the second conventional broadband antenna unit illustrated in FIGS. 3A and 3B at a frequency f of 10 GHz; and

FIG. 10 is a view showing frequency characteristics of gains in a +z direction of the broadband antenna units illustrated in FIGS. 7A and 7B and FIGS. 3A and 3B.

### DESCRIPTION OF THE PREFERRED EMBODIMENT

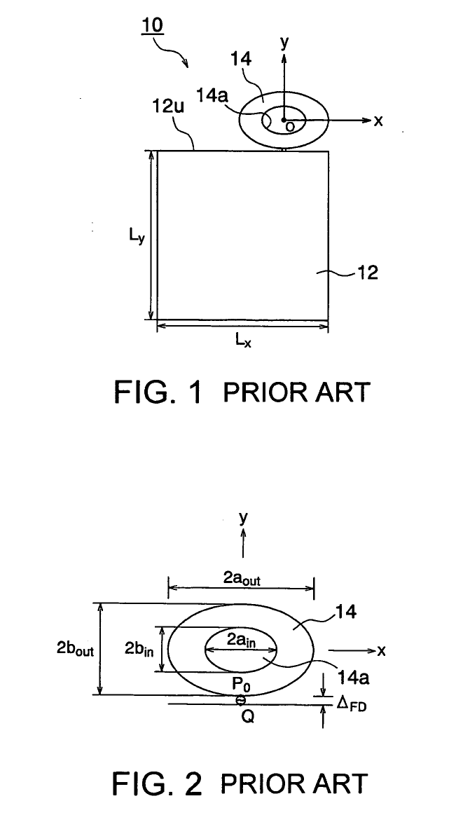

Referring to FIGS. 1 and 2, a first conventional broadband antenna unit 10 will be described at first in order to facilitate an understanding of the present invention. The illustrated broadband antenna unit 10 comprises an elliptically shaped ring broadband antenna disclosed in the above-mentioned first paper. FIG. 1 is a plan view of the broadband antenna unit 10 while FIG. 2 is an enlarged plan view showing a radiation element for use in the broadband antenna unit illustrated in FIG. 1

The broadband antenna unit 10 comprises a ground plate 12 and a radiation element 14. Herein, as shown in FIG. 1, the origin point is a center of radiation element 14, an x-axis extends laterally (in a width direction; a horizontal direction) and a y-axis extends longitudinally (up and down).

The ground plate 12 has a rectangular shape which has a x-direction length of Lx and a y-direction length of Ly. In the example being illustrated, the x-direction length Lx is equal to 45 mm and the y-direction length Ly is equal to 45 mm. That is, the ground plate 12 has a square shape having one side of 45 mm.

In the vicinity of an upper edge (an upper side) 12u of the ground plate 12, the radiation element 14 is disposed to the right of a center thereof. The radiation element 14 has a flat shape disposed in a plane (x, y) in which the ground plate 12 extends. The radiation element 14 is made of a conductive plate. Accordingly, the radiation element 14 does not use dielectrics such as a radiation element for the UWB antenna unit disclosed in the above-mentioned JP 2005-94437 A.

Referring now to FIG. 2, structure of the radiation element 14 will be described in detail. The radiation element 14 has an elliptic shape. It will be assumed that the radiation element 14 has a major outside diameter 2aₒᵤₜ in an ellipse's major axis direction (in the x-direction) and a minor outside diameter 2bₒᵤₜ in an ellipse's minor axis direction (in the y-direction). In this event, the outside shape of the radiation element 14 is the elliptic shape on the plane (x, y) that is represented by:

x²/aₒᵤₜ²+y²/bₒᵤₜ²=1 (aₒᵤₜ>bₒᵤₜ 0).

In the example being illustrated, the major outside diameter 2aₒᵤₜ is equal to 24 mm while the minor outside diameter 2bₒᵤₜ is equal to 15 mm. That is, a ratio between the major outside diameter 2aₒᵤₜ and the minor outside diameter 2bₒᵤₜ is 8:5.

As shown in FIG. 2, the radiation element 14 and the ground plate 12 are apart from each other by a predetermined feeding distance Δ_{FD}. Through the feeding distance Δ_{FD}, the ground plate 12 is provided with a ground feeding point Q and the radiation element 14 is provided with a signal feeding point Po. In the example being illustrated, the feeding distance Δ_{FD} is equal to 0.375 mm.

In the example being illustrated, the elliptically shaped radiation element 14 has an elliptically shaped opening 14a which is concentric with the elliptically shaped radiation element 14. The elliptically shaped radiation element 14 may not have the elliptically shaped opening 14a. Herein, it will be assumed that the elliptically shaped opening 14a has a major inside diameter 2aᵢₙ in the ellipse's major axis direction (the x-direction) and a minor inside diameter 2bᵢₙ in the ellipse's minor axis direction (the y-direction).

In the example being illustrated, a minor inside radius bᵢₙ in the y-direction is set so that bᵢₙ=3.75 mm. Accordingly, the minor inside diameter 2bᵢₙ is equal to 7.5 mm. In other words, the minor inside diameter 2bᵢₙ is half of the minor outside diameter 2bₒᵤₜ. In addition, in the example being illustrated, a major inside radius aᵢₙ in the x-direction is set so that aᵢₙ=6 mm. Accordingly, the major inside diameter 2aᵢₙ is equal to 12 mm. In other words, the major inside diameter 2aᵢₙ is half of the major outside diameter 2aₒᵤₜ. That is, a ratio between an outside diameter and an inside diameter of the elliptically shaped radiation element 14 becomes 2:1. The major inside diameter 2aᵢₙ may less than half of the major outside diameter 2aₒᵤₜ.

At any rate, inasmuch as the first conventional broadband antenna unit 10 comprises the ground plate 12 which is larger in size than that of the elliptically shaped radiation element 14, it is desirable to shrink the ground plate 12.

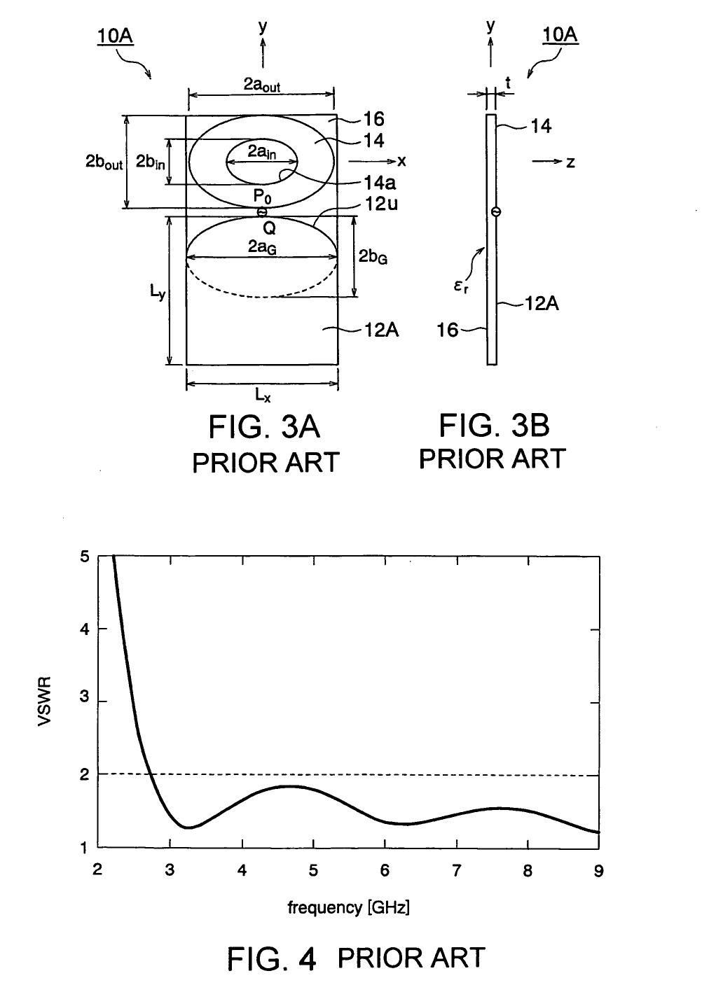

Referring to FIGS. 3A and 3B, a second conventional broadband antenna unit 10A will be described in order to facilitate an understanding of the present invention. The illustrated broadband antenna unit 10A comprises an elliptically shaped ring broadband antenna disclosed in the above-mentioned second paper. FIG. 3A is a plan view showing the broadband antenna unit 10A and FIG. 3B is a side view showing the broadband antenna unit 10A.

The illustrated broadband antenna unit 10A is substantially similar in structure to the broadband antenna unit 10 illustrated in FIG. 1 except that the ground plate is modified from that illustrated in FIG. 1 as will later become clear. The ground plate is therefore depicted at 12A. However, the broadband antenna unit 10A comprises a substrate 16 having a relative permittivity εᵣ of 2.6 and a thickness t of 0.5 mm. The elliptically shaped radiation element 14 and the ground plate 12A are formed on the substrate 16 by printing. As shown in FIGS. 3A and 3B, the origin point is a center of radiation element 14, an x-axis extends laterally (in a width direction), a y-axis extends longitudinally, and a z-axis extends in a thickness direction (in a height direction).

The substrate 16 comprises a dielectric substrate made of a resin such as Teflon (registered trademark) having a little loss in a high-frequency region. The elliptically shaped radiation element 14 and the ground plate 12A may be formed by etching copper foil formed on the substrate 16. On the other hand, when the substrate 16 comprises a ceramic substrate, the elliptically shaped radiation element 14 and the ground plate 12A may be formed by silver pasting.

The illustrated ground plate 12A has a shape of a maximum y-direction length Ly and an x-direction length Lx where an opposite edge (an upper edge) 12u opposed to the elliptically shaped radiation element 14 has a semi-elliptical shape. That is, between the signal feeding point Po for the radiation element 14 and the ground feeding point Q for the ground plate 12A, the radiation element 14 and the ground plate 12A are most close to each other by the feeding distance Δ_{FD}. A distance between the radiation element 14 and the ground plate 12A increases with distance from the feeding point Q in the width direction x. In the example being illustrated, the x-direction length Lx is equal to 25 mm and the maximum y-direction length Ly is equal to 25 mm. The semi-elliptical shape of the ground plate 1 2A has a major diameter 2a_{G} of 25 mm in an ellipse's major axis direction (the x-direction) and a minor radius b_{G} of 7.5 mm in an ellipse's minor axis direction (the y-direction). In addition, the feeding distance ΔFD is equal to 0.25 mm.

At any rate, the upper edge (upper side) 12u of the ground plate 12A has a semi-elliptically shaped curve. With the broadband antenna unit 10A having such a structure, it is possible to decrease an area of the ground plate 12A that is about 71% of that of the ground plate 12 of the first conventional broadband antenna unit 10.

In the elliptically shaped radiation element 14, a ratio between the outside diameter and the inside diameter is 2:1. That is, aₒᵤₜ/aᵢₙ=bₒᵤₜ/bᵢₙ=2. More specifically, in the elliptically shaped radiation element 14, the major outside diameter 2aₒᵤₜ is equal to 24 mm, the minor outside diameter 2bₒᵤₜ is equal to 15 mm, the major inside diameter 2aᵢₙ is equal to 12 mm, and the minor inside diameter 2bᵢₙ is equal to 7.5 mm.

In the manner which is well known in the art, it is generally preferable for an antenna characteristic required to an antenna unit that a voltage standing wave ratio (VSWR) is close one as much as possible. Desirably, the VSWR may be not more than two.

FIG. 4 shows a frequency characteristic of a VSWR of the broadband antenna unit 10A. The illustrated frequency characteristic of the VSWR is analyzed by using the finite-difference time-domain method (FDTDM). In FIG. 4, the abscissa represents a frequency [GHz] and the ordinate represents the VSWR. As seen in FIG. 4, it is understood that the broadband antenna unit 10A illustrated in FIGS. 3A and 3B has the VSWR of 2 or less in a frequency range which is not less than 2.8 GHz.

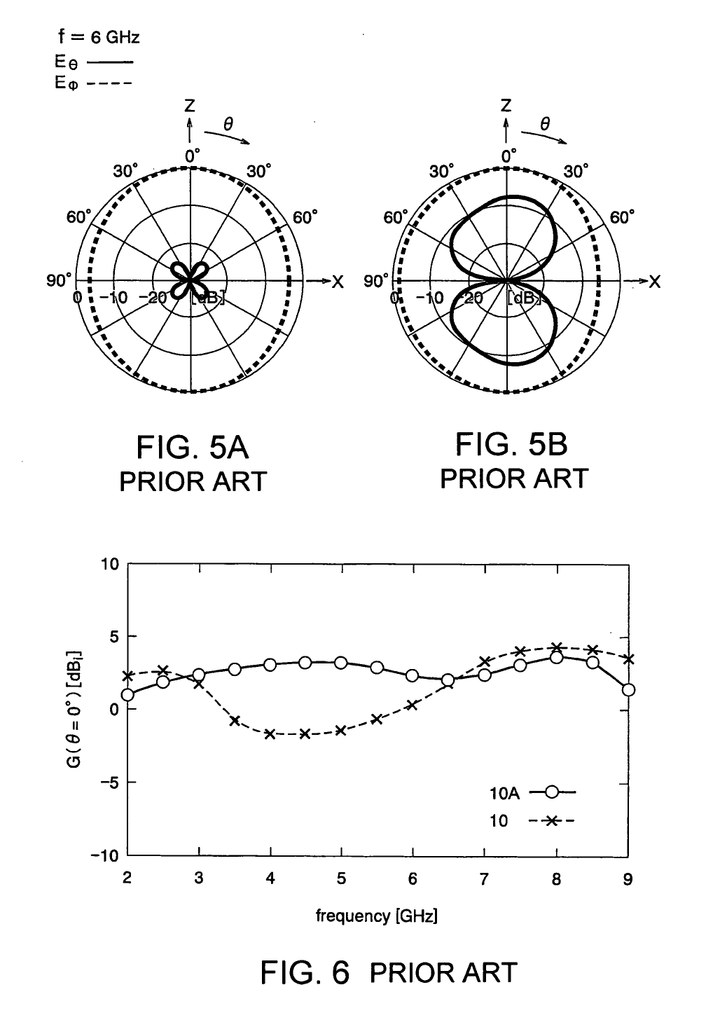

FIGS. 5A and 5B show radiation patterns of the broadband antenna unit 10A illustrated in FIGS. 3A and 3B and of the broadband antenna unit 10 illustrated in FIG. 1. FIG. 5A shows the radiation pattern of the second conventional broadband antenna unit 10A illustrated in FIGS. 3A and 3B at a frequency f of 6 GHz and FIG. 5B shows the radiation pattern of the first conventional broadband antenna unit 10 illustrated in FIG. 1 at a frequency f of 6 GHz. As seen in FIGS. 5A and 5B, it is understood that the broadband antenna unit 10A illustrated in FIGS. 3A and 3B has a decreased cross-polarization radiation field component E_{θ} in compassion with that of the broadband antenna unit 10 illustrated in FIG. 1.

FIG. 6 shows frequency characteristics of a gain G in a +z-direction of the broadband antenna units 10A and 10 illustrated in FIGS. 3A and 3B and FIG. 1. In FIG. 6, the abscissa represents a frequency [GHz] and the ordinate represents the gain G (θ=0°) [dBi]. In FIG. 6, a curve of O shows the frequency characteristic of the gain of the broadband antenna unit 10A illustrated in FIGS. 3A and 3B and a curve of X shows the frequency characteristic of the gain of the broadband antenna unit 10 illustrated in FIG. 1. As seen in FIG. 6, it is understood that the broadband antenna unit 10A illustrated in FIGS. 3A and 3B has less variations of the gain compared with that of the broadband antenna unit 10 illustrated in FIG. 1.

In the manner which is described above, it is possible to realize the broadband antenna unit 10A which has the shrunk ground plate 12A and which has the VSWR of two or less in the frequency range of 2.8 GHz or more by opposing the ground plate 12A having the semi-elliptically shaped upper edge 12u against the elliptically shaped radiation element 14.

However, the broadband antenna unit 10A is disadvantageous in that a gain in a +z direction decreases at or more than a frequency of 9 GHz in the manner which will become clear at the description proceeds.

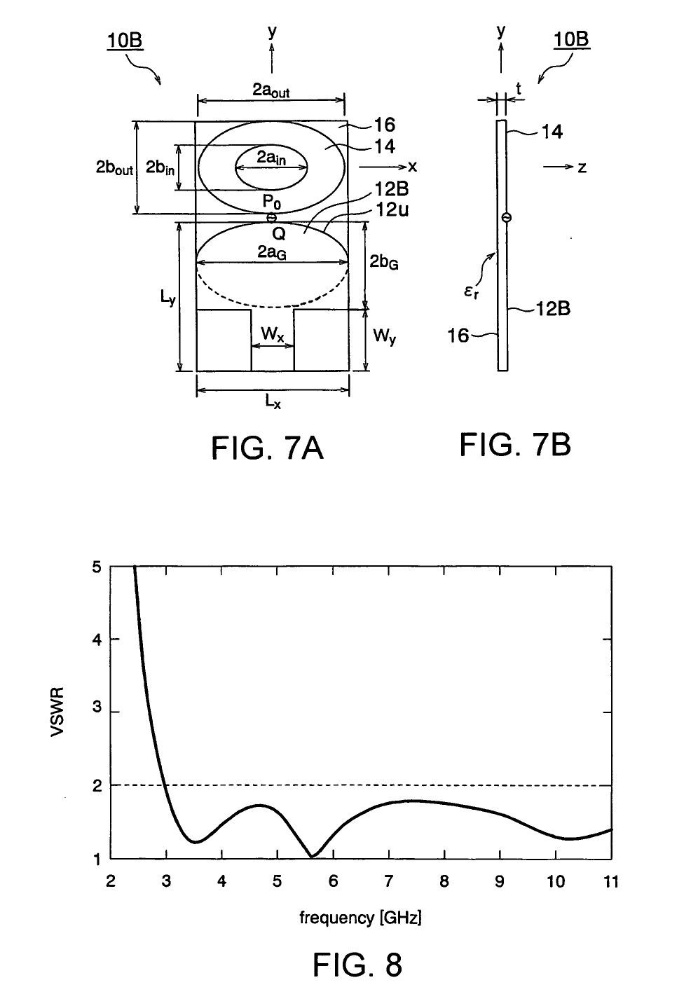

Referring to FIGS. 7A and 7B, the description will proceed to a broadband antenna unit 10B according to an embodiment of this invention. FIG. 7A is a plan view showing the broadband antenna unit 10B and FIG. 7B is a side view showing the broadband antenna unit 10B.

The illustrated broadband antenna unit 10B is similar in structure to the broadband antenna unit 10A illustrated in FIGS. 3A and 3B except that the ground plate is modified from that illustrated in FIGS. 3A and 3B as will later become clear. The ground plate is therefore depicted at 12B. As shown in FIGS. 7A and 7B, the origin point is a center of the radiation element 14, an x-axis extends laterally (in a width direction), a y-axis extends longitudinally, and a z-axis extends in a thickness direction (in a height direction).

The illustrated ground plate 12B is similar in structure to the ground plate 12A illustrated in FIGS. 3A and 3B except that the ground plate 12B has a lower portion where both side corner portions are deleted by a length Wy with a central portion of a width Wx left. More specifically, the width Wx is equal to 7 mm and the length Wy is equal to 10 mm. At any rate, the ground plate 12B has the so-called mushroom-like shape.

FIG. 8 shows a frequency characteristic of a VSWR of the broadband antenna unit 10B. The illustrated frequency characteristic of the VSWR is analyzed by using the finite-difference time-domain method (FDTDM). In FIG. 8, the abscissa represents a frequency [GHz] and the ordinate represents the VSWR. As seen in FIG. 8, it is understood that the broadband antenna unit 10A illustrated in FIGS. 7A and 7B has the VSWR of 2 or less in a frequency range which is not less than 2.9 GHz.

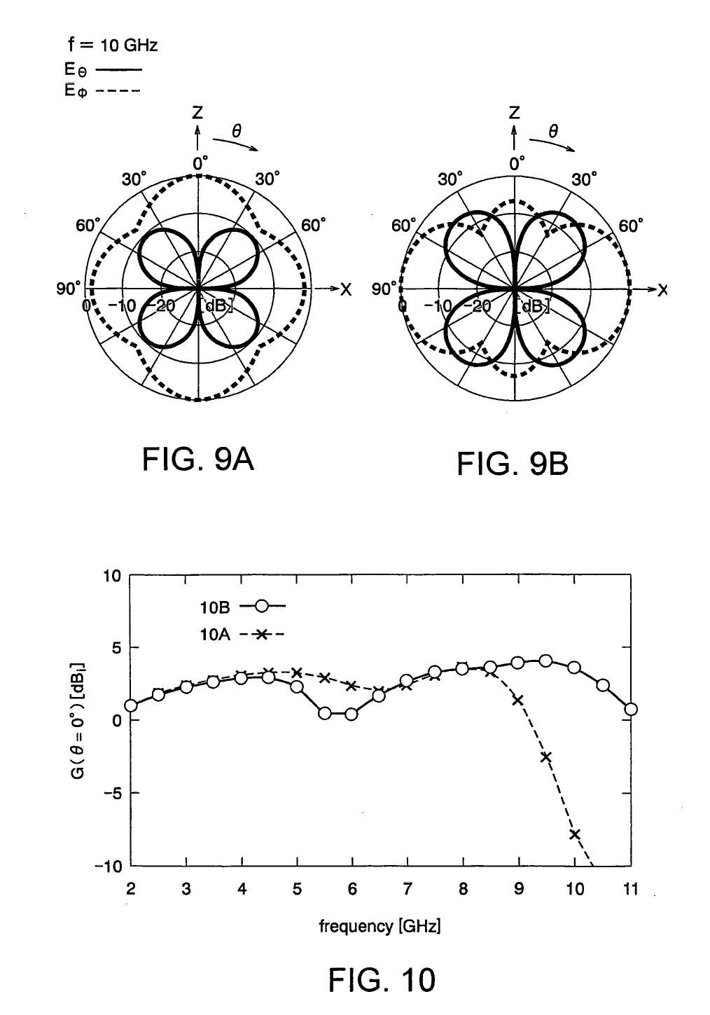

FIGS. 9A and 9B show radiation patterns of the broadband antenna unit 10B illustrated in FIGS. 7A and 7B and of the broadband antenna unit 10A illustrated in FIGS. 3A and 3B. FIG. 9A shows the radiation pattern of the broadband antenna unit 10B illustrated in FIGS. 7A and 7B at a frequency f of 10 GHz and FIG. 9B shows the radiation pattern of the second conventional broadband antenna unit 10A illustrated in FIGS. 3A and 3B at a frequency f of 10 GHz. As seen in FIGS. 9A and 9B, it is understood that the broadband antenna unit 10B illustrated in FIGS. 7A and 7B has the improved radiation pattern in the +z direction at the frequency of 10 GHz in compassion with that of the broadband antenna unit 10A illustrated in FIGS. 3A and 3B.

FIG. 10 shows frequency characteristics of a gain G in the +z-direction of the broadband antenna units 10B and 10A illustrated in FIGS. 7A and 7B and FIGS. 3A and 3B. In FIG. 10, the abscissa represents a frequency [GHz] and the ordinate represents the gain G (θ=0°) [dBi]. In FIG. 10, a curve of O shows the frequency characteristic of the gain of the broadband antenna unit 10B illustrated in FIGS. 7A and 7B and a curve of X shows the frequency characteristic of the gain of the broadband antenna unit 10A illustrated in FIGS. 3A and 3B. As seen in FIG. 10, it is understood that the broadband antenna unit 10B illustrated in FIGS. 7A and 7B has the improved gain at or more than the frequency of 9 GHz compared with that of the broadband antenna unit 10A illustrated in FIGS. 3A and 3B.

In the manner which is described above, it is possible for the broadband antenna unit 10B to improve the gain at or more than the frequency of 9 GHz by deleting or cutting the both side corner portions from the lower portion of the ground plate 12B.

While this invention has thus far been described in conjunction with a preferred embodiment thereof, it will now be readily possible for those skilled in the art to put this invention into various other manners. For example, the ratio between the major outside diameter and the minor outside diameter of the elliptically shaped radiation element 14 is not restricted to one of the above-mentioned embodiment. In addition, a size of the elliptically shaped opening 14a in the radiation element 14 is not restricted to one of the above-mentioned embodiment.

What is claimed is:

1. A broadband antenna unit comprising:
a ground plate; and
an elliptically shaped radiation element disposed at an upper portion of said ground plate in a plane where said ground plate extends,
wherein said ground plate has a semi-elliptically shaped upper edge and a lower portion where both side corner portions are deleted with a central portion left.

2. The broadband antenna unit as claimed in claim 1, wherein further comprises a substrate on which said ground plate and said radiation element are formed.

3. The broadband antenna unit as claimed in claim 1, wherein said radiation element and said ground plate are apart from each other by a predetermined feeding distance.

4. The broadband antenna unit as claimed in claim 1, said elliptically shaped radiation element having a major outside diameter in an ellipse's major axis direction and a minor outside diameter in an ellipse's minor axis direction, wherein a ratio between the major outside diameter and the minor outside diameter is 8:5.

5. The broadband antenna unit as claimed in claim 1, wherein said elliptically shaped radiation element has an elliptically shaped opening which is concentric with said elliptically shaped radiation element.

6. The broadband antenna unit as claimed in claim 5, said elliptically shaped opening having a minor inside diameter in the ellipse's minor axis direction, wherein the minor inside diameter is half of the minor outside diameter.

7. The broadband antenna unit as claimed in claim 5, said elliptically shaped opening having a major inside diameter in the ellipse's major axis direction, wherein the major inside diameter is not more than half of the major outside diameter.
